(19) United States
(12) Patent Application Publication
(10) Pub. No.: US 2006/0136764 A1
(43) Pub. Date: Jun. 22, 2006

(54) Methods and apparatus to manage power consumption of a system

(76) Inventor: Peter R. Munguia, Chandler, AZ (US)

Correspondence Address: INTEL CORPORATION, P.O. BOX 5326, SANTA CLARA, CA, 95056-5326, US

(21) Appl. No.: 11/021,499

(22) Filed: Dec. 22, 2004

(51) Int. Cl. G06F 1/26

(52) U.S. Cl. 713/322

(57) ABSTRACT

A method and apparatus to manage power consumption of a system is provided. The method may include altering power consumption of a stream processing system based on information from a data stream to be processed by the stream processing system. Other embodiments are described and claimed.

### BACKGROUND

Processors may be designed to operate at speeds selected for processing a maximum anticipated data rate. Such operation may be undesirable in terms of power consumption if data rates of data streams to be processed vary over a wide range. For example, system power usage may be greater than necessary when relatively low-speed data rates are encountered.

### BRIEF DESCRIPTION OF THE DRAWINGS

FIG. 1 is a block diagram illustrating a portion of a system in accordance with an embodiment of the present invention;

FIG. 2 is a flow diagram illustrating a method in accordance with an embodiment of the present invention; and

FIG. 3 is a flow diagram illustrating a method in accordance with an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the present invention. However, it will be understood by those skilled in the art that the present invention may be practiced without these specific details. In other instances, well-known methods, procedures, components and circuits have not been described in detail so as not to obscure the present invention.

In the following description and claims, the terms “include” and “comprise,” along with their derivatives, may be used, and are intended to be treated as synonyms for each other. In addition, in the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Further, “coupled” may mean that two or more elements are indirectly joined together, for example, via one or more other elements.

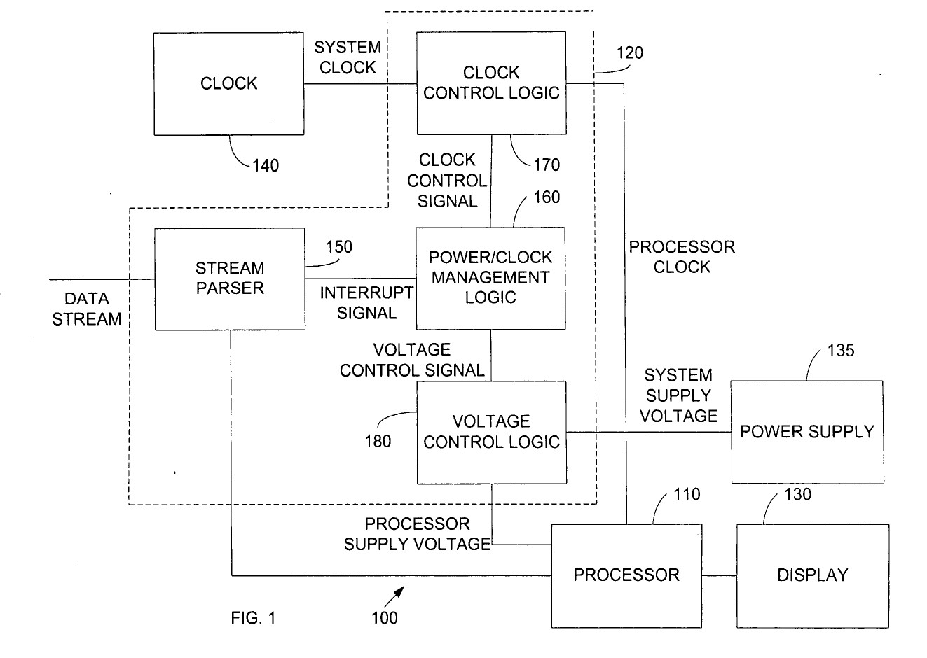

FIG. 1 is a block diagram illustrating a portion of a system 100 in accordance with an embodiment of the present invention. Although the scope of the present invention is not limited in this respect, system 100 may be used in a laptop or desktop computer, a set-top box, a television, a personal digital assistant (PDA), a wireless telephone (for example, cordless or cellular phone), other consumer electronic devices, etc.

System 100 may include a processor 110 and control logic 120. Although the scope of the present invention is not limited in this respect, in some embodiments, processor 110 may be optionally coupled to a display 130 such as, for example, a cathode ray tube (CRT) display or a liquid crystal display (LCD). Although not shown, system 100 may include other components such as, for example, more processors, input/output (I/O) devices, memory devices, or storage devices. However, for simplicity these additional components have not been shown.

Although the scope of the present invention is not limited in this respect, in various embodiments, processor 110 may be a state machine, an application specific integrated circuit (ASIC), a microprocessor, co-processor, or a microcontroller. In various embodiments, control logic 120 may be implemented using hardware (e.g., circuitry) and/or software (e.g., code or firmware). In the embodiment illustrated in FIG. 1, control logic 120 may receive a data stream (labeled DATA STREAM) and a system clock signal (labeled SYSTEM CLOCK), and may provide a processor clock signal (labeled PROCESSOR CLOCK) to processor 110. System 100 may include a clock 140 to generate the SYSTEM CLOCK.

In addition, control logic 120 may receive a system power supply voltage (labeled SYSTEM SUPPLY VOLTAGE) and may provide a processor supply voltage (labeled PROCESSOR SUPPLY VOLTAGE) to processor 110. System 100 may include a power supply 135 to generate the PROCESSOR SUPPLY VOLTAGE.

Generally, system 100 may be referred to as a stream processing system and control logic 120 may be referred to as power control logic. Control logic 120 may be adapted or arranged to alter power consumption of a stream processing system, e.g., system 100, based upon information from a data stream to be processed by the stream processing system. As will be discussed below in more detail, in various embodiments control logic 120 may alter the PROCESSOR SUPPLY VOLTAGE or the PROCESSOR CLOCK based on information in the DATA STREAM to alter power consumption of processor 110 which also may alter power consumption of the overall system 100.

In various embodiments, altering power consumption of system 100 may be implemented using clock throttling, clock gating, or powering down different logic of system 100. Clock throttling may include turning the full speed clock on and off at regular intervals to emulate a reduced clock frequency. Clock gating may include completely stopping the toggling of some logic of system 100.

The operating or processing speed of processor 110 may be determined by the frequency of the clock signal PROCESSOR CLOCK. In addition, altering the frequency of the PROCESSOR CLOCK may alter power consumption of the processor, which also may alter power consumption of the overall system 100. For example, reducing or decreasing the frequency of the PROCESSOR CLOCK may reduce the power consumption of processor 110, and conversely, increasing the frequency of PROCESSOR CLOCK may increase the power consumption of processor 110.

In some embodiments, control logic 120 may be adapted or arranged to alter the frequency of the. PROCESSOR CLOCK using information in the DATA STREAM to alter power consumption of processor 110. The type of information, amount of information, or the data rate of the DATA STREAM may vary over time. One approach to processing a data stream that may have a variable data rate, is to fix the frequency of the processor clock so processor 110 operates at a maximum operating speed to handle the highest anticipated data rate of an incoming data stream. Compared to a system that uses a fixed frequency processor clock, having a system that includes logic such as control logic 120 that alters the frequency of the processor clock based on information in the received data stream may be advantageous in terms of managing power consumption of the system.

Processor 110 may receive and process at least a portion of the DATA STREAM. For example, in some embodiments, the DATA STREAM may be a video data stream that includes video data. Processor 110 may be a video decode processor which may decode the video data stream to, for example, display content encoded in the video data stream on display 130. In some embodiments, processor 110 may be referred to as a stream processor.

Continuing with the example wherein the DATA STREAM is a video data stream, in some embodiments, screen resolution or display resolution may be determined by control logic 120 using information contained in the DATA STREAM. In some embodiments, to alter power consumption of processor 110, control logic 120 may alter the frequency of the PROCESSOR CLOCK based on the display resolution information. For example, control logic 120 may alter the frequency of the PROCESSOR CLOCK in response to a change in the display resolution. The data rate of a video data stream may be determined or calculated using the display resolution information and control logic 120 may alter the frequency of the PROCESSOR CLOCK based on the data rate of the received video data stream.

In some embodiments, control logic 120 may increase the frequency of the PROCESSOR CLOCK if the information in the video data stream indicates that the display resolution has increased. For example, control logic 120 may increase the frequency of the PROCESSOR CLOCK if the information in the video data stream indicates that the video stream is a high definition video stream. Conversely, control logic 120 may decrease the frequency of the PROCESSOR CLOCK if the information in the video stream indicates that the display resolution has decreased, thereby reducing the power consumption of processor 110. For example, control logic 120 may decrease the frequency of the PROCESSOR CLOCK if the information in the video data stream indicates that the video data stream is a standard definition video stream.

As an example, standard definition video streams may be 480 vertical pixels by 480 horizontal pixels sent/displayed in an interleaved fashion (480i) at 12 bits per pixel and at 60 fields, or 30 frames, per second. This results in 480×480×30×12 data bits per second (compressed into about 2 megabits per second) of data to process. On the other hand, high definition video stream may be 1920 horizontal pixels by 1080 vertical pixels sent/displayed in progressive fashion (1080p) at 24 bits per pixel and at 30 frames per second. This results in 1920×1080×24×30 data bits per second (compressed into about 20 megabits per second) of data to process. This display resolution information may be used to dynamically control the frequency of the PROCESSOR CLOCK to manage power consumption of processor 110. For example, the frequency of the PROCESSOR CLOCK may be altered if a change is the display resolution is detected by control logic 120. In other words, the clock frequency of the PROCESSOR CLOCK may be based on incoming resolution changes. Accordingly, in some embodiments, clock frequency management of a video decode processor may be based on the display resolution value parsed from the incoming DATA STREAM.

Although the scope of the present invention is not limited in this respect, in some embodiments, control logic 120 may include a stream parser 150, power/clock management logic 160, clock control logic 170, and voltage control logic 180. Stream parser 150 may receive the DATA STREAM, which may be a video stream, and may determine display resolution using information in the video data stream. In addition stream parser 150 may provide a signal such as, for example, an interrupt signal (labeled INTERRUPT SIGNAL) in response to a change in the display resolution. The INTERRUPT SIGNAL may be sent to power/clock management logic 160.

The video data stream may include one or more video channels and one or more audio channels, wherein the information for multiple audio and video channels may be mixed together and sent in a single stream. In some embodiments, stream parser 150 may be transport stream demux and may parse the video channels and audio channels and may forward only a selected audio channel and video channel to processor 110 for processing, wherein processor 110, for example, processes the selected video channel for displaying on display 130.

Stream parser 150 may be a hardware state machine or a central processing unit (CPU) driven state machine. Stream parser 150 may search the incoming stream and only allow a portion of the stream to pass through, that is, stream parser may parse out information. Stream parser may also be referred to as a filter. For example, stream parser may be a program ID filter (PID) filter that allows only selected PID packets to pass.

Although not shown, in some embodiments, an input first in first out (FIFO) may be coupled to the input of stream parser 150. This input FIFO may create some elasticity in system 100 to allow time for power/clock management logic 160 to act without losing information.

Power/clock management logic 160 may be coupled to stream parser 150 to receive the INTERRUPT SIGNAL. In addition, power/clock management logic 160 may provide a clock control signal (labeled CLOCK CONTROL SIGNAL) in response to the INTERRUPT SIGNAL. The CLOCK CONTROL SIGNAL may be sent to clock control logic 170. In response to the CLOCK CONTROL SIGNAL, clock control logic 170 may alter the frequency of the PROCESSOR CLOCK, thereby altering the power consumption of processor 110. Clock control logic 170 may also be referred to as clock throttling logic, and clock control logic 170 may use clock throttling or clock gating.

Further, power/clock management logic 160 may provide a voltage control signal (labeled VOLTAGE CONTROL SIGNAL) in response to the INTERRUPT SIGNAL. The VOLTAGE CONTROL SIGNAL may be sent to voltage control logic 180. In response to the VOLTAGE CONTROL SIGNAL, voltage control logic 180 may alter the voltage level of the VOLTAGE CONTROL SIGNAL, thereby altering the power consumption of processor 110.

By way of example, processor 110 may be a video decoder (e.g., an MPEG-2 decoder) processing a high definition television program signal. The MPEG standards are an evolving set of standards for video and audio compression and for multimedia delivery developed by the Moving Picture Experts Group (MPEG). The video decoder may be operating at 250 megahertz (MHz) for this example. A news alert may interrupt the program. The news alert may be broadcast in a standard definition format. Stream parser 150 may be an MPEG-2 parser that recognizes the resolution change in the data stream, and may trigger the an interrupt (or direct signal) to allow the system to reduce the MPEG-2 decoder clock to, for example, 125 MHz to process the new reduced resolution stream. At the end of the news alert, the video steam may be returned to the high definition program signal. Stream parser 150 may then again recognize the resolution change in the data stream, and trigger another interrupt (or direct signal) that may allow control logic 120 to return the MPEG-2 decoder clock to 250 MHz to process the high definition stream.

In some embodiments, to alter power consumption of processor 110, control logic 120 may alter the PROCESSOR SUPPLY VOLTAGE based on the display resolution information. For example, control logic 120 may increase the PROCESSOR SUPPLY VOLTAGE if the information in the video data stream indicates that the video stream is a high definition video stream. Conversely, control logic 120 may decrease the PROCESSOR SUPPLY VOLTAGE to reduce the power consumption of processor 110 if the information in the video data stream indicates that the video data stream is a standard definition video stream, thereby reducing power consumption of the overall system.

In some embodiments, control logic 120 may be adapted or arranged to determine the data rate of the DATA STREAM using information in the DATA STREAM and to alter the frequency of the PROCESSOR CLOCK based on the data rate of the DATA STREAM to alter power consumption of the processor. In other embodiments, control logic 120 may be adapted or arranged to alter the PROCESSOR SUPPLY VOLTAGE based on the data rate of the DATA STREAM to alter power consumption of the processor.

Although some of the embodiments above discuss a video system and the processing of a video data stream, this is not a limitation of the present invention. Embodiments of the present invention may also be used to process other types of data streams in other types of systems. For example, system 100 may be used to process audio data streams or Ethernet data streams.

In some embodiments, the DATA STEAM may be an Ethernet data stream and control logic 120 may determine the data rate of the Ethernet data stream using information in the Ethernet data stream. In some embodiments, control logic 120 may alter the frequency of the PROCESSOR CLOCK based on the data rate of the Ethernet data stream to alter power consumption of processor 110. Processor 110 may be a network controller to process the Ethernet data stream. In other embodiments, control logic 120 may alter the voltage of the PROCESSOR SUPPLY VOLTAGE based on the data rate of the Ethernet data stream to alter power consumption of processor 110.

By way of example, in an Ethernet stream, the data may include information about the type of file and the data rate. For example, the Ethernet stream may communicate that it is sending a streaming file (e.g., multi-media file) at a particular data rate. With this information, a system may configure its pipeline, including memory buffers for the traffic. If the stream is video, this could be 20 megabits per second for a high definition picture. This may be lower than the theoretical bandwidth of the associated Ethernet port, e.g., one gigabit Ethernet. In this case, in addition to configuring memory buffers, the system may configure the power on the pipeline as well. The pipeline may include the stream parser and also downstream codecs (coder/decoder) which may also process the data stream.

In some embodiments, the DATA STEAM may be an audio data stream and control logic 120 may use information in the audio data stream to alter the frequency of the PROCESSOR CLOCK to alter power consumption of processor 110. For example, an audio data stream may include number of audio channels (e.g., number of channels per speaker) and the granularity of the signal sent (e.g. 16 bit audio, 20 bit audio, or 24 bit audio). In a mono system, one channel may be sent. In a stereo system, two channels may be sent. In a 5.1 system six channels may be sent. In a 7.1 system eight channels may be sent. Accordingly, if control logic 120 determines transmission is 5.1 instead of stereo, then it may be determined that approximately three times as many data bits are to be processed. On the other hand, if control logic 120 determines transmission is stereo instead of 5.1, then it may be determined that fewer data bits are to be processed. Therefore, control logic 120 may decrease the frequency of the PROCESSOR to process the fewer number of data bits. In addition, control logic 120 may decrease the PROCESSOR SUPPLY VOLTAGE to process the fewer number of data bits.

As discussed above, in various embodiments, methods and apparatuses are provided that may use incoming stream information to control clocks and power of a system. In addition, some of the methods and apparatuses discussed above in the various embodiments provide a system to dynamically manage power based on the bit rate of an incoming data stream and on processing information contained in the data stream, thereby reducing overall energy consumption of the system.

Although the various embodiments discussed above discussed power adjustment with respect to processor 110, this is not a limitation of the present invention. Any part or component of system 100 may have its power adjusted based on information in the incoming data stream. For example, the stream parser of system 100 may have its power adjusted based on information in the incoming data stream.

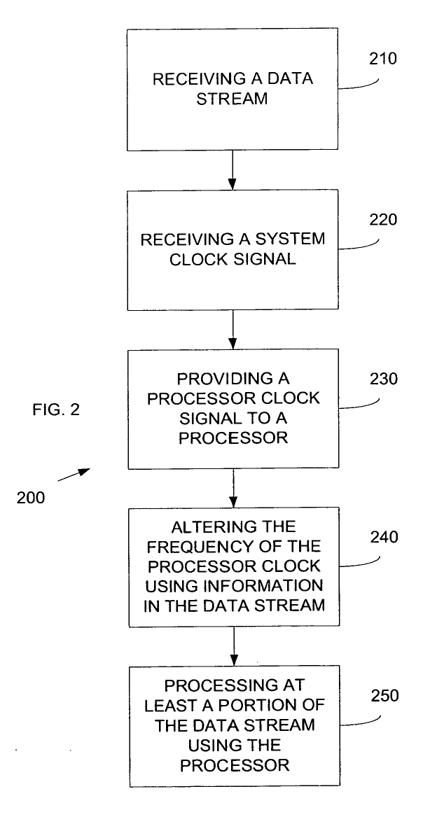

Turning to FIG. 2, shown is a flow diagram illustrating a method 200 to manage power consumption of a processor in accordance with an embodiment of the present invention. This method may be described with reference to system 100 of FIG. 1. It should be noted that the methods described herein do not have to be executed in the order described, or in any particular order.

Method 200 may begin with receiving the DATA STEAM (block 210) and may also include receiving the SYSTEM CLOCK signal (block 220). Method 200 may further include processing the SYSTEM CLOCK signal to provide the PROCESSOR CLOCK to processor 110 (block 230). In addition, method 200 may include altering the frequency of the PROCESSOR CLOCK using information in the DATA STREAM to alter power consumption of processor 110 (block 240). Although the scope of the present invention is not limited in this respect, the actions in blocks 210-240 may be performed using control logic 120. Method 200 may also include processing at least a portion of the DATA STREAM using processor 110 (block 250).

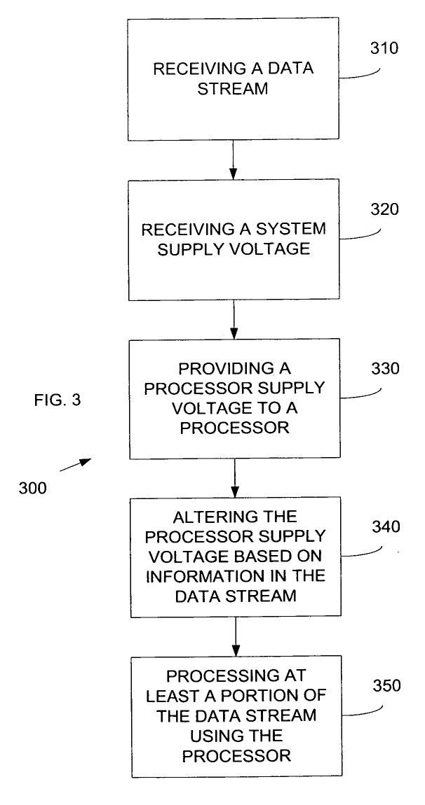

Turning to FIG. 3, shown is a flow diagram illustrating a method 300 to manage power consumption of a processor in accordance with an embodiment of the present invention. This method may be described with reference to system 100 of FIG. 1. It should be noted that the methods described herein do not have to be executed in the order described, or in any particular order.

Method 300 may begin with receiving the DATA STEAM (block 310) and may also include receiving the SYSTEM SUPPLY VOLTAGE (block 320). Method 300 may further include processing the SYSTEM SUPPLY VOLTAGE to provide the PROCESSOR SUPPLY VOLTAGE to processor 110 (block 330). In addition, method 300 may include altering the voltage of the PROCESSOR SUPPLY VOLTAGE based on information in the DATA STREAM to alter power consumption of processor 110 (block 340). Although the scope of the present invention is not limited in this respect, the actions in blocks 310-340 may be performed using control logic 120. Method 300 may also include processing at least a portion of the DATA STREAM using processor 110 (block 350).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method, comprising:
determining display resolution using information in a video data stream;
altering the frequency of a clock signal coupled to a processor based on the display resolution to alter power consumption of the processor; and
processing at least a portion of the video data stream using the processor.

2. The method of claim 1, further comprising determining a data rate of the video data stream using the display resolution and wherein altering the frequency of the clock signal includes altering the frequency of the clock signal based on the data rate of the video data stream.

3. The method of claim 2, wherein altering the frequency of the clock signal includes reducing the frequency of the clock signal in response to a change in the data rate of the video data stream to reduce power consumption of the processor.

4. The method of claim 1, wherein the processor is a video decode processor and wherein the processing includes decoding the video data stream using the video decode processor.

5. The method of claim 1, further comprising sending an interrupt to power management logic if a change in the display resolution is detected.

6. The method of claim 5, wherein altering the frequency of the clock signal includes reducing the frequency of the clock signal in response to the interrupt signal to reduce power consumption of the processor.

7. The method of claim 1, wherein the video data stream includes at least two video channels and at least two audio channels and further comprising:
parsing the video channels and audio channels; and
providing one video channel of the at least two channels to the processor for processing and providing one audio channel of the at least two channels to the processor for processing, and wherein the processor processes the video channel for displaying on a display.

8. The method of claim 1, wherein altering the frequency of the clock signal includes increasing the frequency of the clock signal if the information in the video data stream indicates that the display resolution has increased.

9. The method of claim 1, wherein altering the frequency of the clock signal comprises:
decreasing the frequency of the clock signal if the information in the video data stream indicates that the video data stream is a standard definition video stream; and
increasing the frequency of the clock signal if the information in the video data stream indicates that the video data stream is a high definition video stream.

10. A method to manage power consumption of a processor, comprising:
altering the frequency of a clock signal using information in a data stream, wherein the processor is coupled to receive the clock signal and wherein altering the frequency of the clock signal alters power consumption of the processor; and
processing at least a portion of the data stream using the processor.

11. The method of claim 10, wherein altering the frequency of the clock signal using information in the data stream comprises:
determining the data rate of the data stream using information in the data stream; and
altering the frequency of the clock signal coupled to the processor based on the data rate of the data stream to alter power consumption of the processor.

12. The method of claim 10, wherein the data stream is a video data stream and the processor is a video decode processor.

13. The method of claim 12, wherein altering the frequency of the clock signal using information in the data stream comprises:
determining display resolution using information in the video stream;
altering the frequency of the clock signal in response to a change in the display resolution to alter power consumption of the processor.

14. The method of claim 10, wherein the data stream is an audio data stream and wherein altering the frequency of the clock signal using information in the data stream comprises:
determining the number of audio channels using information in the audio data stream; and
altering the frequency of the clock signal based on the number of audio channels.

15. The method of claim 10, wherein the data stream is an Ethernet data stream and altering the frequency of the clock signal using information in the data stream comprises:
determining the data rate of the Ethernet data stream using information in the data stream;
altering the frequency of the clock signal based on the data rate of the Ethernet data stream to alter power consumption of the processor.

16. A system, comprising;
a processor coupled to receive a clock signal, the processor to process at least a portion of a video data stream; and
control logic to determine display resolution using information in the video data stream and to alter the frequency of the clock signal based on the display resolution to alter power consumption of the processor.

17. The system of claim 16, wherein the control logic comprises:
a steam parser to receive the video data stream and to determine the display resolution using information in the video data stream and to provide an interrupt signal in response to a change in the display resolution;
power management logic coupled to the processor and to the stream parser to receive the interrupt signal, the power management logic to provide a clock control signal in response to the interrupt signal; and
clock control logic coupled to the power management logic , the clock control logic to alter the frequency of the clock signal in response to the clock control signal to alter power consumption of the processor.

18. The system of claim 17, wherein the processor is a video decode processor and further comprising:
a clock coupled to the clock control logic, wherein the clock control logic is coupled between the clock and the processor; and
a first in first out (FIFO) coupled to an input of the stream parser.

19. The system of claim 16, further comprising a display coupled to the processor.

20. The system of claim 16, wherein the control logic decreases the frequency of the clock signal if the information in the video data stream indicates that the video data stream is a standard definition video stream and the control logic increases the frequency of the clock signal if the information in the video data stream indicates that the video data stream is a high definition video stream.

21. A system, comprising;
a processor coupled to receive a clock signal, the processor to process at least a portion of a data stream and wherein the processing speed of the processor is determined by the frequency of the clock signal; and
control logic to determine the data rate of the data stream using information in the data stream and to alter the frequency of the clock signal based on the data rate of the data stream to alter power consumption of the processor.

22. The system of claim 21, wherein the data stream is a video data stream, the processor is a video decode processor, and the information in the data stream is display resolution information.

23. The system of claim 21, wherein the data stream is an audio data stream and wherein the information is number of audio channels.

24. The system of claim 21, wherein the data stream is an Ethernet data stream and the processor is a network controller.

25. The system of claim 21, wherein the system is a set-top box.

26. The system of claim 21, wherein the system is a computer.

27. The system of claim 21, wherein the system is a television.

28. A method, comprising:
altering power consumption of a stream processing system based on information from a data stream to be processed by the stream processing system.

29. The method of claim 28, wherein altering power consumption of the stream processing system includes:
altering a supply voltage coupled to a processor of the stream processing system using information in the data stream, wherein altering the supply voltage alters power consumption of the processor; and
processing at least a portion of the data stream using the processor.
